(19) United States
(12) Patent Application Publication
(10) Pub. No.: US 2024/0079225 A1
(43) Pub. Date: Mar. 7, 2024

(54) LIQUID FLOW/AIR FLOW COMBINATION FOR SAMPLE TRANSPORT

(71) Applicant: DH Technologies Development Pte. Ltd., Singapore (SG)

(72) Inventors: Thomas R. COVEY, Newmarket (CA); Peter KOVARIK, Markham (CA)

(73) Assignee: DH Technologies Development Pte. Ltd., Singapore (SG)

(21) Appl. No.: 18/262,829

(22) PCT Filed: Feb. 3, 2022
(86) PCT No.: PCT/IB2022/050963

§ 371 Date: Jul. 25, 2023

Related U.S. Application Data
(60) Provisional application No. 63/181,629, filed on Apr. 29, 2021.
(60) Provisional application No. 63/145,247, filed on Feb. 3, 2021.

(51) Int. Cl. H01J 49/24; F17D 1/00; G01N 1/10; G01N 35/10; H01J 49/04; H01J 49/16

(52) U.S. Cl. CPC H01J 49/24; F17D 1/005; G01N 1/10; G01N 35/1095; H01J 49/0404; H01J 49/167; B67D 99/00

(57) ABSTRACT

A method of delivering transport fluid from an open port interface to an outlet via a transfer conduit includes delivering, to the open port interface, a transport liquid at a first flow rate. The open port interface is disposed in a pressure environment having a first pressure. A second pres-sure is applied at the outlet, wherein the second pressure is less than the first pressure. The pressure applied at the outlet generates a motive flow on the transport liquid, thereby drawing into the transfer conduit (a) the transport fluid, wherein the transport fluid is in contact with a wall of the transport conduit, and (b) a gas present in the pressure environment. The gas forms an air core within the drawn transport fluid. The air core extends substantially an entire length of the transfer conduit.

### CROSS-REFERENCE TO RELATED APPLICATIONS

This application is being filed on Feb. 3, 2022, as a PCT International Patent Application and claims the benefit of and priority to U.S. Provisional Application No. 63/145,247, filed Feb. 3, 2021, and U.S. Provisional Application No. 63/181,629, filed on Apr. 29, 2021, the disclosures of which are hereby incorporated by referenced herein in their entirety.

### BACKGROUND

High-throughput sample analysis is critical to the drug discovery process. Mass spectrometry (MS) based methods can achieve label-free, universal mass detection of a wide range of analytes with exceptional sensitivity, selectivity, and specificity. As a result, there is significant interest in improving the throughput of MS-based analysis for drug discovery. In particular, a number of sample introduction systems for MS-based analysis have been improved to provide higher throughput. Acoustic droplet ejection (ADE) has been combined with an open port interface (OPI) to provide a sample introduction system for high-throughput mass spectrometry. When an ADE device and OPI are coupled to a mass spectrometer, the system can be referred to as an acoustic ejection mass spectrometry (AEMS) system. The analytical performance (sensitivity, reproducibility, throughput, etc.) of an AEMS system depends on the performance of the ADE device and the OPI. The performance of the ADE device and the OPI depends on selecting the operational conditions or parameters for these devices. AEMS technology brings fast, precisely controlled, low-volume sampling to the electrospray ionization (ESI) transport liquid without carry-over, to enable a high-throughput analytical platform with good reproducibility, and wide compound coverage.

### SUMMARY

In one aspect, the technology relates to a method of delivering transport fluid from an open port interface to an outlet via a transfer conduit, the method including: delivering, to the open port interface, a transport liquid at a first flow rate, wherein the open port interface is disposed in a pressure environment having a first pressure; applying a second pressure at the outlet, wherein the second pressure is less than the first pressure, wherein the pressure applied at the outlet generates a motive flow on the transport liquid, thereby drawing into the transfer conduit (a) the transport fluid, wherein the transport fluid is in contact with a wall of the transport conduit, and (b) a gas present in the pressure environment, wherein the gas forms an air core within the drawn transport fluid, wherein the air core extends substantially an entire length of the transfer conduit. In an example, the first pressure is an atmospheric pressure and the second pressure is a pressure reduced below the atmospheric pressure. In another example, the entire length of the transfer conduit is defined at a first end by a sample inlet of the open port interface and at a second end by the outlet. In yet another example, the outlet includes an outlet of a nebulizer capillary. In still another example, the air core extends along about 95% of the entire length.

In another example of the above aspect, the air core extends along about 99% of the entire length. In an example, the air core extends along the entire length.

In another aspect, the technology relates to a method of operating an analysis device including an open port interface, a transfer conduit coupled to the open port interface, and a detector disposed proximate an outlet of the transfer conduit, the method including: delivering, to the open port interface, a transport liquid at a first flow rate, wherein the open port interface is disposed in a pressure environment having a first pressure; generating a second pressure at the outlet of the transfer conduit, wherein the transfer conduit includes a length, wherein the second pressure is less than the first pressure, wherein the pressure applied at the outlet generates a motive flow on the transport liquid, thereby drawing into the transfer conduit (a) the transport fluid, wherein the transport fluid is in contact with a wall of the transport conduit, and (b) a gas present in the pressure environment, wherein the gas forms an air core within the drawn transport fluid; ejecting the transport liquid from the outlet of the transfer conduit; analyzing the ejected transport liquid with the detector, wherein the analyzed ejected transport fluid is defined by a first condition; and adjusting a conduit length of the transfer conduit until the analyzed ejected transport fluid is defined by a second condition. In an example, the length of the transfer conduit is defined at a first end by a sample inlet of the open port interface and at a second end by the outlet. In another example, the air core includes an air core length, wherein the air core length includes a first air core length at the first condition and a second air core length at the second condition. In yet another example, in the first condition, the analyzed ejected transport fluid includes an unresolved signal, and wherein in the second condition, the analyzed ejected transport fluid includes a resolved signal. In still another example, the unresolved signal and the resolved signal are based on at least one of a signal peak, a signal width, and a noise.

In another example of the above aspect, the second air core length includes substantially all of the conduit length. In an example, the second air core length includes about 90% of the conduit length. In another example, the second air core length includes about 95% of the conduit length. In yet another example, the second air core length includes about 99% of the conduit length.

In another aspect, the technology relates to a sample transfer conduit for delivering transport liquid from an open port interface to a mass spectrometer, the sample transfer conduit including: a proximal end disposed in an atmospheric pressure environment and configured to receive a transport liquid and a sample; a distal end disposed remote from the proximal end; an ionization source connected to the distal end, wherein the ionization source is configured to operate at a pressure lower than the atmospheric pressure, wherein a pressure difference between the ionization source and the proximal end provides a motive force to the transport liquid through the conduit, wherein a flow of the transport liquid and the sample is disposed along the conduit walls, and wherein a flow of gas is generated within the flow of the transport liquid and the sample. In an example, the flow of gas is generated along substantially the entire length of the sample transfer conduit. In another example, the flow of gas is generated through a continuous gas channel. In yet another example, a length of the sample transfer conduit is less than about 5 cm. In still another example, the ionization source includes an electrospray ionization source.

### BRIEF DESCRIPTION OF THE DRAWINGS

FIGS. 1A-1C depict partial cross-sectional views of a system depicting a sample droplet introduced to an OPI.

FIG. 1D is a schematic view of an example system combining ADE with an OPI sampling interface and ESI source.

FIG. 2A depicts an example plot of peak width versus conduit length for three experimental conditions.

FIG. 2B depicts an example of a relationship between detected sample peak width and flow rate.

FIG. 2C a plot of a relationship between sample transit time and flow rate.

FIG. 3A-3B depict operational conditions and performance under an air core flow mode.

FIG. 3C depicts operational conditions and performance under a flow mode other than air core mode.

FIG. 3D depicts high throughput performance under an air core flow mode.

FIG. 4 depicts a method of delivering transport fluid from an OPI to an outlet via a transfer conduit.

FIG. 5 depicts an example of a suitable operating environment in which one or more of the present examples can be implemented.

### DETAILED DESCRIPTION

The technologies described herein were previously described in U.S. Provisional Patent Application Ser. No. 63/145,247, filed Feb. 3, 2021, entitled “Liquid Flow/Air Flow Combination for Sample Transport,” the disclosure of which is hereby incorporated by reference herein in its entirety. The technologies described herein control certain combinations of nebulizer gas aspiration, transport fluid flow, and transport conduit length, to attain an ultra-shaped peak width signal in an MS device. This may allow for higher analytical throughput, depending on the sample introduction speed and/or the peak width. When used in a system where sample introduction speed and peak width are commensurate in performance, the air core operational mode described in further detail below provides significant speed and sample throughput improvements compared to conventional liquid flow, as well as to the current standard operation of an OPI. In addition to OPI, the technologies described herein could also be extended to other analytical processes, such as flow injection analysis, which does not necessarily use MS as a detector. Further, the technologies described may also be applied to extremely low-volume systems, such as microfluidic systems.

The OPI allows for significant improvement to sample throughput in a MS system. The technologies described herein are focused on achieving very high sample throughput through introduction of a new flow mode (as used herein an “air core” flow mode) for the sample transport flow. This flow mode consists of a continuous air core that extends a significant length of the transfer conduit. The distance the air core extends within the transfer conduit may be a function of at least one of the conduit length and size, and may be further controlled by the reduced pressure at the nebulizer probe (e.g. at the electrode nozzle of an ESI), as that reduced pressure differs from the environmental pressure at the OPI, as well as by transport fluid rate to the OPI. In a first example, the reduced pressure may be due to a venturi reduction. In another example, the reduced pressure may be due to a shockwave structure of a sonic expansion. This shockwave structure may produce a larger pressure drop at the electrode nozzle. In examples, the air core may extend the entire length of the transfer conduit from the interface or sample inlet at the OPI all the way to the electrode nozzle.

In examples, the air core flow mode is attained by achieving a balance between the conduit length, conduit radius, pressure pull, and flow rate, such that the system reaches a condition that may be described as “over-pumped”. Over-pumped flow, in one example, means that the transport liquid delivered into the OPI port is far less than the balanced flow at that drive pressure; balanced flow, in one example, means that the transfer pipe is completely filled by only a liquid and can be described by the Hagen-Poiseuille equation. Balanced flow may also be referred to as “closed flow”). If the over-pumped transfer conduit is of an appropriate length, the OPI liquid surface meniscus formed by the transport fluid is stretched through the transfer conduit to a location at or near an end thereof. This forms a substantially continuous air core through the length of the transfer conduit with the liquid confined to a shell along the conduit wall. Typically, the ability to maintain a substantially continuous air core flow mode requires a relatively short transfer conduit.

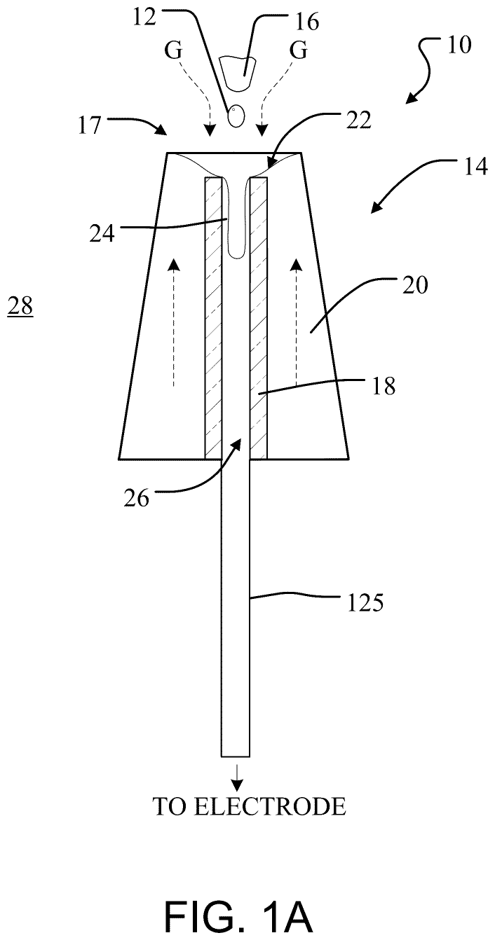

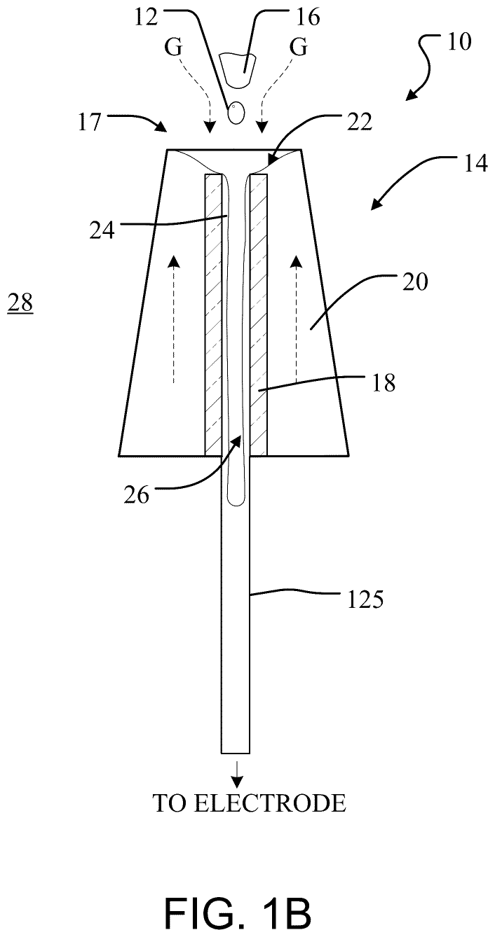

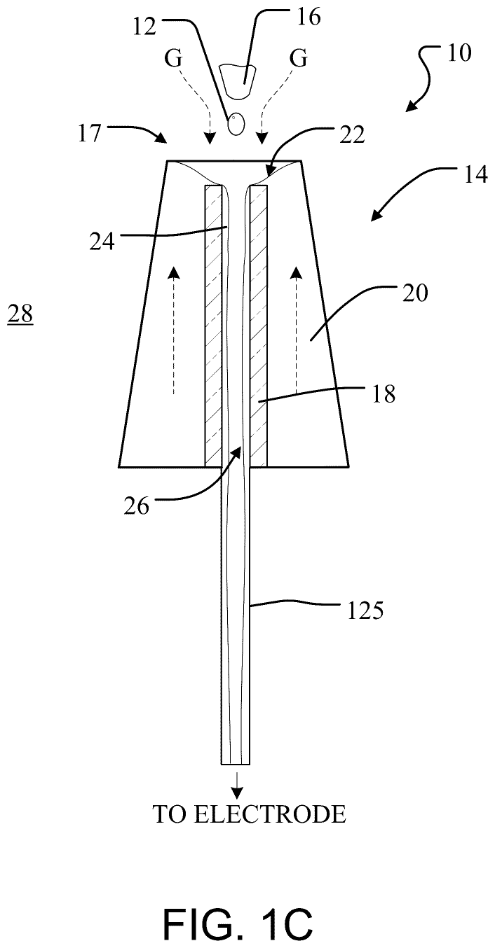

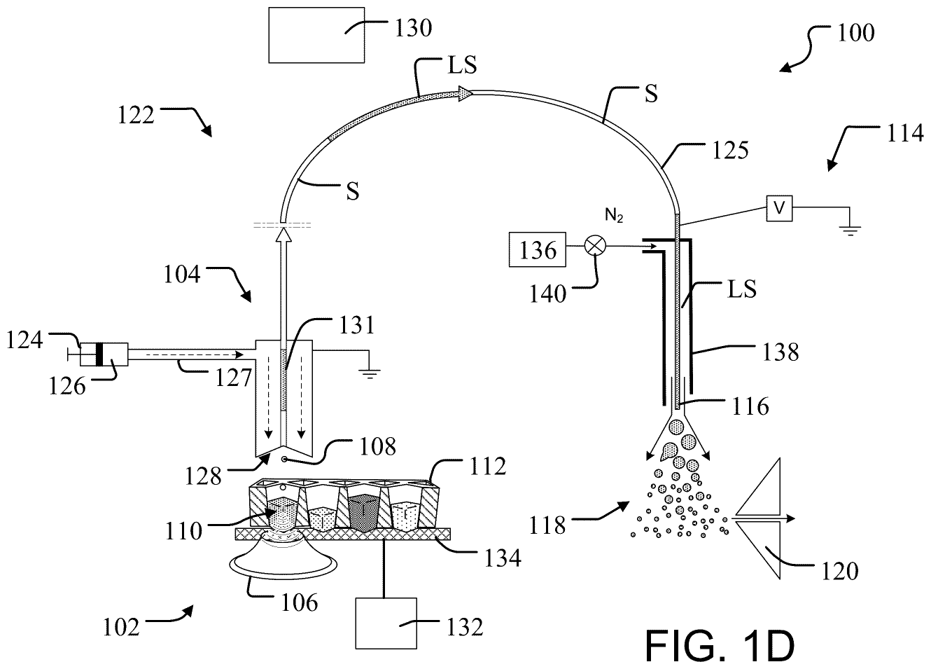

FIGS. 1A-1C depict partial cross-sectional views of a system 10 depicting a sample droplet 12 introduced to an OPI 14 in an air core flow mode. FIGS. 1A-1C depict a generation of a gas core 26 within a sample removal conduit 18 and a transfer conduit 125 of a system 10 (e.g., such as depicted in FIG. 1D). FIG. 1A depicts the meniscus 22 beginning to be drawn into the sample removal conduit 22. FIG. 1B depicts the meniscus 22 stretching into the sample removal conduit 18 of as flowrate is reduced while the pull force at the conduit exit remains constant. It does not show onset of the air core mode as the air channel is not fully formed through the entire length of the conduit but it shows the progression towards that flow mode. FIG. 1C shows air ingest into a fully formed air core flow mode, where the air core 26 is present.

The droplet 12 is released from a sample source 16 into the port inlet 17. In other examples, the droplet may be ejected (upwards) from a well plate (e.g., via contactless ejection such as ADE). The OPI 14 includes a sample removal conduit 18 substantially surrounded by a transport liquid supply conduit 20. Transport liquid (depicted by dashed arrows) is delivered via the transport liquid supply conduit 20 and forms a liquid meniscus 22. Thereafter, the transport liquid is aspirated into the sample removal conduit 18 due to the pressure drop at the nebulizer probe (depicted in FIG. 1B). The aspiration pressure drop draws the meniscus 22 into the sample removal conduit 18, thereby forming a liquid flow 24 consisting of the transport liquid and the sample. The sample is diluted with the transport liquid as it flows into the sample removal conduit 18. The liquid flow 24 is disposed along and against the walls of the sample removal conduit 18, thereby forming a gas air core 26 therein. The gas air core 26 (FIG. 1C, specifically) is comprised of gas G drawn from the surrounding environment 28, which may be room air, a sterile curtain gas, or some other gas.

As the air core 26 is drawn further and further into the OPI (as indicated in FIGS. 1A-1C), the liquid flow 24 is further driven by the fast-moving gas within the air core 26. This results in a fast flow along the liquid/air interface and a steep velocity gradient to the wall of the sample removal conduit 18, which is communicatively coupled to a transfer conduit 125. For a given liquid flowrate, the linear speed is enhanced by the reduced cross-sectional area of the liquid as compared to the sample removal conduit 18.

Experiments have been performed that included a transfer conduit length of 4.3 cm, an ESI nebulizer nozzle driven at 92 psi (16 L/min), and low viscosity transport fluid including Acetonitrile and Methanol. In one experiment, a transport liquid flow rate is reduced while the pull exerted by the pressure gradient between the nebulizer nozzle and the OPI 14 remains constant, resulting in an increasing degree of over-pumping and extending the meniscus 22 of the liquid flow 24 deeper into the sample removal conduit 18 and, ultimately, into the transfer conduit 125.

As the over-pumping increases and if the transfer conduit 125 length is sufficiently short, the meniscus 22 is stretched into the transfer conduit 125 until the air core 26 is formed through a length of the conduit 125. Depending on the particular application, that length may be all, or a significant portion of, the transfer conduit 125. The transfer conduit 125, in some cases, may be measured from the OPI inlet 17 to the opening of the electrode (as depicted in FIG. 1B), which may be positioned within, substantially coextensive with, or protruding from the nebulizer nozzle. For transfer conduits 125 having a length of less than about 10 cm, desirable results may be obtained with an air core 26 that extends along about 90% of the transfer conduit 125 (as measured from the OPI inlet 17). Air cores that display desirable performance may extend along about 95% of the conduit, about 97% of the conduit, about 99% of the conduit, and about 100% of the conduit. Air core lengths of about 90% to 100%, of about 95% to 100%, of about 97% to 100%, and about 99% to 100% are contemplated.

With the air core flow mode described, further context for a system 100 that benefits from such an operational condition is depicted in FIG. 1D. FIG. 1D is a schematic view of an example system 100 combining an ADE 102 with an OPI sampling interface 104 and an ionization source 114 (in this case, an ESI source). The system 100 may be a mass analysis instrument such as a mass spectrometry device that is for ionizing and mass analyzing analytes received within an open end of a sampling OPI. Such a system 100 is described, for example, in U.S. Pat. No. 10,770,277, the disclosure of which is incorporated by reference herein in its entirety. The ADE 102 includes an acoustic ejector 106 that is configured to eject a droplet 108 from a well plate 112 into the open end of sampling OPI 104. As shown in FIG. 1B, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are turned into gas phase. A liquid handling system 122 (e.g., including one or more pumps 124 and one or more transfer conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within a sample space accessible at the open end such that one or more droplets 108 can be introduced into the port inlet 128 at the sample tip and subsequently delivered to the ESI source 114, by being drawn first into a sample removal conduit 131 within the OPI 104.

The system 100 includes an ADE 102 that is configured to generate acoustic energy that is applied to a liquid contained within a reservoir 110 that causes one or more droplets 108 to be ejected from the reservoir 110 into the open end of the sampling OPI 104. A controller 130 can be operatively coupled to the ADE 102 and can be configured to operate any aspect of the ADE 102 (e.g., focusing structures, acoustic ejector 106, automation elements 132 for moving a movable stage 134 so as to position a reservoir 110 into alignment with the acoustic ejector 106, etc.). This enables the ADE 106 to inject droplets 108 into the sampling OPI 104 as otherwise discussed herein substantially continuously or for selected portions of an experimental protocol by way of non-limiting example. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1B, the ESI source 114 can include a source 136 of pressurized gas (e.g. nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include discrete volumes of liquid samples LS received from each reservoir 110 of the well plate 112. The discrete volumes of liquid samples LS are typically diluted and separated from each other by volumes of the solvent S (hence, as flow of the solvent moves the liquid samples LS from the OPI 104 to the ESI source 114, the solvent may also be referred to herein as a transport liquid). The nebulizer gas can be supplied at a variety of flow rates which can also be controlled under the influence of controller 130 (e.g., via opening and/or closing valve 140).

It will be appreciated that the flow rate of the nebulizer gas can be adjusted (e.g., under the influence of controller 130) such that the closed flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference under high-field and low-field conditions. Additionally, it will be appreciated that the mass analyzer detector 120 can comprise a detector that can detect the ions that pass through the analyzer detector 120 and can, for example, supply a signal indicative of the number of ions per second that are detected.

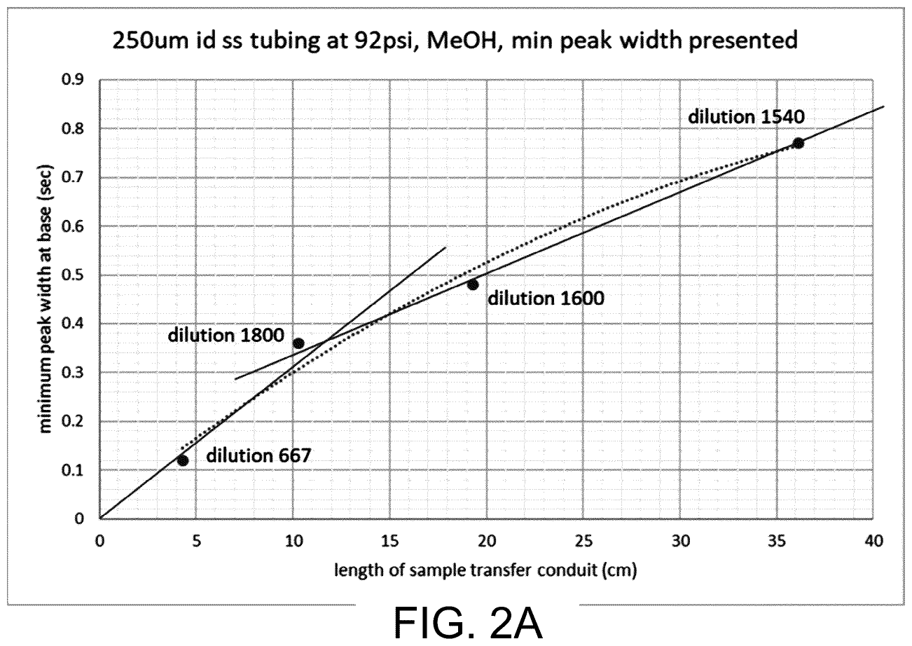

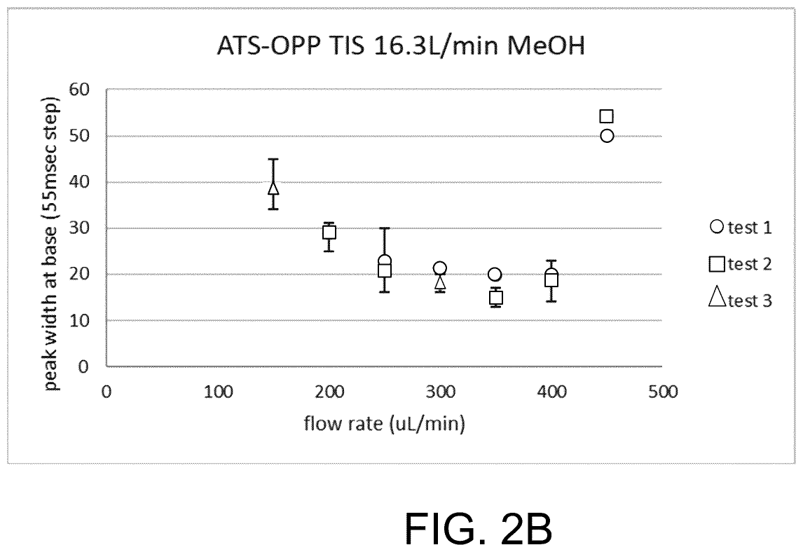

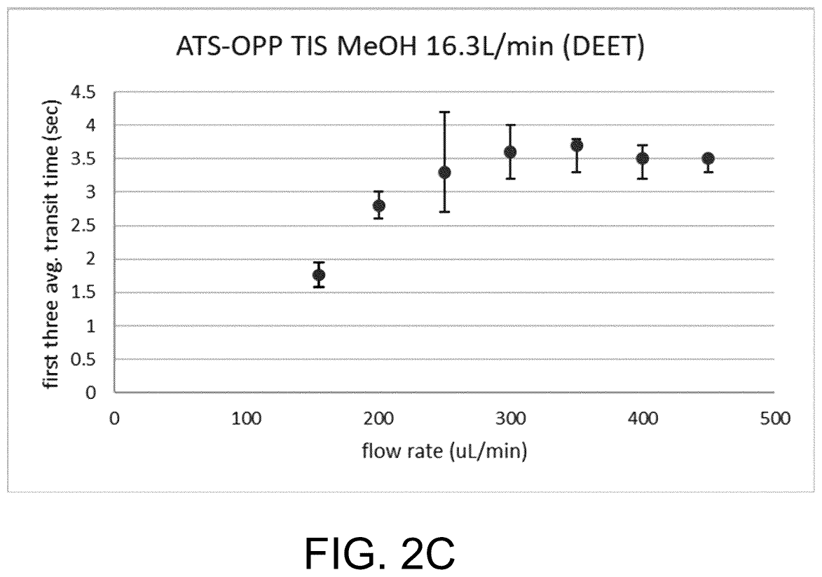

As stated above, the air core allows flow of gas (which was room air in the described experiment) to participate in the equilibration of the reduced pressure at the tip of the electrode. As gas is less viscous and more motive as compared to a liquid, the core will move much faster than the liquid, thus carrying the liquid with it by friction and entrainment. This represents the air core mode. In an example, the air core mode may correspond to a super critical mode where the air core extends through all, or substantially all, of the transfer conduit length. Existence of the air core flow mode is supported by the observed discontinuity in FIG. 2A; it describes the behavior of a sample peak width as the length of the transfer conduit is reduced while the pull force is kept constant. The pull force is due to the reduced pressure region at the tip of the electrode, relative to the pressure at the inlet of the OPI. This reduced pressure region is created by the expanding nebulizer gas. In mass spectrometry devices used in many labs, the pressure at the OPI is atmospheric pressure; thus, the pressure generated at the tip of the electrode is reduced relative to atmospheric. Regardless of the pressure environment in which the OPI is located, the pressure generated at the tip of the electrode is again less than the pressure environment in which the OPI operates. For example, the OPI may be in a positive pressure environment (e.g., greater than atmospheric) if it is located in an environment under positive pressure to maintain sterility of the ejected samples.

FIG. 2A depicts an example plot of peak width versus conduit length for four experimental conditions. The top three points (identified as “dilution 1800”, “dilution 1600”, and “dilution 1540”) show an expected behavior where the bulk of the dilution occurs in the OPI port and peak width is mostly determined by the sample plug exit time (transit past the ionization source nozzle termination) which can be shown to be linearly dependent on the conduit length. Under a constant pull force (provided by the pressure drop outside the ionization source nozzle termination) the maximum flow rate will increase as conduit length is decreased, since the resistance to the flow drops linearly with conduit length. Hence the flowrates at which optimum peak shape and width occur will also increase as the length decreases. The top three points of the graph show an experimentally obtained linear trend, the expected theoretical dependence. Note, the value associated with each of the above dilution points represents a dilution ratio. The dilution value represents the amount of liquid the sample is diluted into by the time of detection by mass spectrometer, and is characterized by peak width (in seconds) multiplied by transport liquid flow rate (in microliters/second) to produce a final volume. This final volume is divided by the initial sample volume, e.g., the volume of the original sample droplet ejected towards the OPI (e.g., 5 nanoliters).

As the conduit length is decreased, while the pull is kept constant, the flow rate will increase. It can be shown that increasing the flowrate will increase the dilution, a trend shown experimentally by the top three data points. The experimentally determined dilution, volume of the sample peak divided by the sample droplet volume, is increasing for the top three points as the conduit length is reduced and flowrate increases. The first point (dilution 667) of the graph, with the shortest conduit length and narrowest peak width, is an anomaly to the rest of the graph. It does not follow the linear trend of the top three points both in the dilution and peak width. Instead, it is discontinuous with the top three points. The dilution trend is reversed, and peak width drops more rapidly as compared with the rest of the graph. This indicates change in the flow mode as the liquid transfer through the conduit operates in the air core mode. As the fluid does not fill the entire conduit in the air core mode, there is less volume of transport liquid available for the sample to diffuse into, hence dilution is less.

The top three points of FIG. 2A represent OPI operation in a “critical mode” which is characterized by some liquid surface deformation within the OPI inlet (element 17 in FIG. 1A) that stretches the surface towards the outlet of the OPI. Advantageous performance (e.g., as defined at least partially by peak shape and width) is obtained while operating in this flow mode with conduit lengths represented by the top three points. In this flow regime, a desirable peak shape and width are obtained at about 70% to about 80% of the maximum flow at the given pull force. This corresponds to about 70% to about 80% of Hagen-Poiseuille equation flowrate, also the balanced flow rate or the start of overflow flowrate or closed flow), the minimum peak width plotted for the three top points is achieved at 70-80% of the maximum flowrate. The discontinuity forming first point (“dilution 667”) achieves its best peak shape and width at much lower fraction of the maximum flow, about 40%. This also indicates a change in the flow mode.

If the flow rate is reduced below the critical mode, while keeping the pull force unchanged, the flow enters a “super-critical” mode. For the super-critical mode, the liquid surface inside the OPI is stretched and deformed such that it extends into the transfer conduit itself. With typical transfer conduit lengths (e.g., as represented by the top three points of the graph of FIG. 2A) this operation leads to an unstable ion current causing noisy and wider peaks. With transfer conduit lengths greater than about 10 cm, the air core breaks into large bubbles inside the tube that fill it from wall to wall. The large bubbles disrupt the ESI signal causing “noisy” ion current. The disintegration of the air core into large bubbles occurs at between about 5 to about 10 cm after the OPI port inlet. When the conduit is short, e.g., less than about 5 to about 10 cm, the breakup of the air core into large bubbles does not occur, and the air core remains intact in the center with a continuous flow of liquid along the walls, providing stable ion current and fast transport times. This is illustrated by the first point of the graph for which the conduit length is decreased to 4.3 cm, the flow mode changes to the air core and the ion current is again stable, with smooth peaks of the narrowest width.

Presence of the discontinuity within the graph of FIG. 2A can be illustrated in terms of signal attributes, such as peak width and sample transit. FIG. 2B depicts a plot of a relationship between detected sample peak width and flow rate and was generated using a conduit 60 cm long. The plot represents behavior typical of the longer transfer tubes such as the points of FIG. 2A labeled dilution 1800, dilution 1600, and dilution 1540. The 60 cm conduit length forms an extension of the linear section of the graph in FIG. 2A. While FIG. 2A only plots the minimum peak width for each conduit length, FIG. 2B shows the dependence of the peak width on different flowrates at that conduit length and how the minimum peak width is related to the closed flow (H-P flowrate). In FIG. 2B the points at 450 uL/min show the peak width increase typical of the approach to the closed flow. The (best) minimum peak width occurs at about 70% of the closed flow for this conduit length, reducing the flow rate below this value results in a gradual increase of the peak width, an undesirable signal quality. At 40% of the closed flow the peak has widened by almost a factor of two.

FIG. 2C is a plot of a relationship between sample transit time and flow rate. It was generated using a conduit 60 cm long. At the 60 cm conduit length, FIG. 2B and FIG. 2C relate the peak width to a sample transit time through the transfer conduit, again behavior typical of the linear section of the FIG. 2A. The minimum peak width is attained with the longest transit times occurring at about 70-80% of the maximum flow rate.

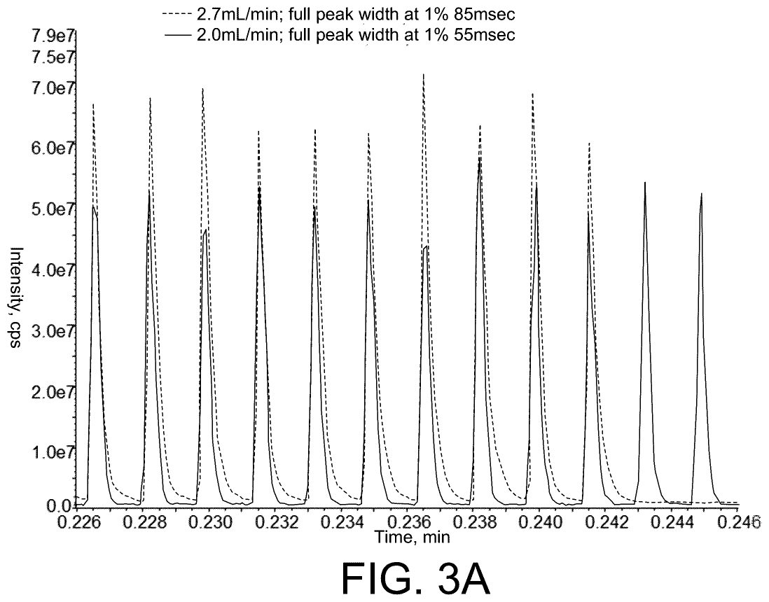

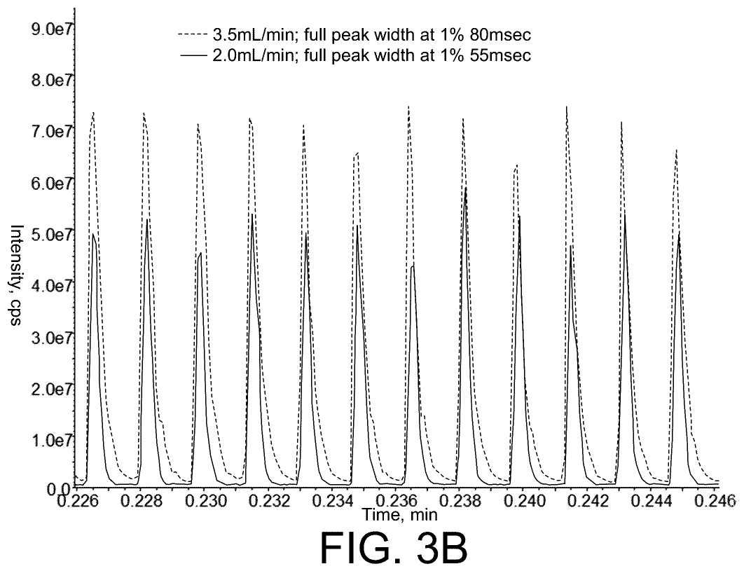

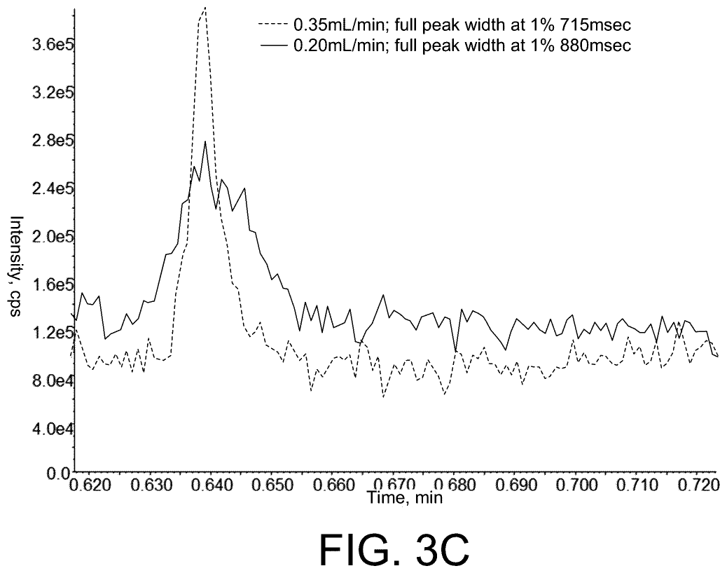

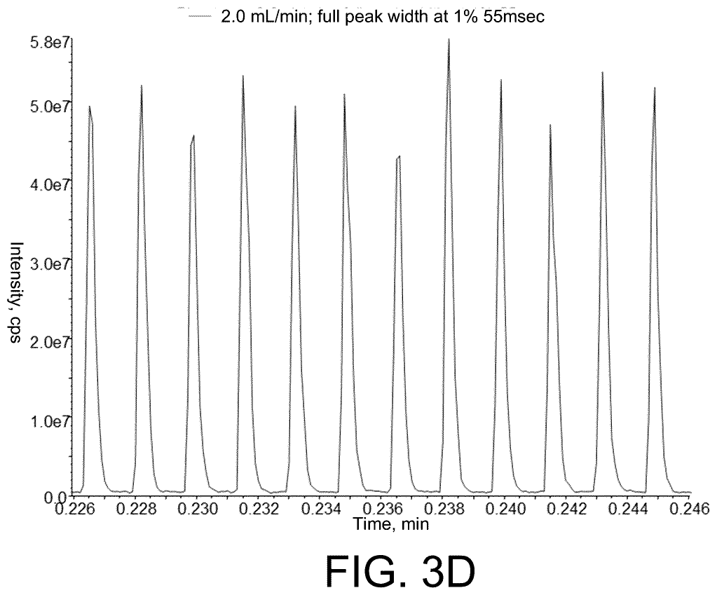

FIG. 3A and FIG. 3B offer a similar comparison to FIG. 2B but for the 4.3 cm transfer conduit length. This conduit length represents the point in FIG. 2A that is discontinuous with the linear section of the graph. It describes the super-critical, air core mode, flow through the transfer conduit. Where FIG. 2B represents the dependence of the peak width on flowrate as a plot, FIG. 3A and FIG. 3B show the dependence as actual peak widths at multiple flowrates that allow a comparison with the behavior shown in FIG. 2B between the different flow regimes (conduit lengths). FIG. 3A and FIG. 3B depict a peak width in the air core mode for flowrate fractions typical of the minimum peak width obtained with the longer transfer conduit. In contrast, for the air core mode, with conduit length of 4.3 cm, desirable performance shifts to about 40% of the maximum flow rate. Maximum flow is 4.3 mL/min for this length, while operating at constant maximum pull force. The comparison highlights the difference between the two flow modes. In FIG. 3A red trace shows that the peak width collected at about 65% of the closed flow has increased from the minimum peak width, blue trace, collected at about 45% of the closed flow by about 1.5×. A behavior inconsistent with that predicted by extrapolation from the linear part of FIG. 2A. The failure of the prediction illustrates the entry of the transport into the new flow mode. In FIG. 3B the 4.3 cm transfer conduit performance compares the minimum peak width at 45% closed flow to 81% of closed flow. If the critical flow mode depicted by the top three points of the FIG. 2A was to extend to this conduit length the peak width would at its minimum, albeit near the limit of that range. This contradicts the observed results, again indicating onset of a different flow mode, air core mode. In both FIG. 3A and FIG. 3B the higher flowrates should have the narrower peaks if the critical flow mode was present, since that is not the case a new flow mode transports the sample. For the critical mode, the minimum peak width occurs at or near the maximum transit time, reducing the flowrate to a lower fraction of the closed flow shortens the transit time. For the 4.3 cm conduit length the minimum peak width occurs at a much lower fraction of the closed flow indicating a faster transit time than that of the flow critical mode.

The peak width dependence on the flowrate, as described above for the air core mode, is reversed when comparing peak shape and width for standard transfer conduit lengths. The reversal is illustrated by FIG. 3C which shows an example of 60 cm transfer conduit with maximum flow (overflow onset) of 500 uL/min (MeOH). FIG. 3C. allows a direct comparison with FIG. 3A and FIG. 3B as both show direct examples of peak shape and width. FIG. 3C represents the standard transfer conduit length where the minimum peak widths are obtained at the critical flow mode, while the FIG. 3A and FIG. 3B depict the 4.3 cm transfer conduit length where the narrowest peaks are associated with the air core flow mode. In FIG. 3C the minimum peak width is shown by the red trace collected at about 70% of the closed flow, it is overlaid by the blue trace collected at about 40% of the closed flow which shows a wider peak by about 1.25×, a trend opposite to that of the air core flow mode. In the critical mode, the lower flow rate peak width is 1.25× worse than that at the higher flow rate, a trend opposite to that observed with the air core mode.

Operating the 4.3 cm conduit length with the air core delivers a more desirable performance. An example is shown in FIG. 3D. From the 55 msec peak with at 1% of the peak height it is possible to estimate the throughput with two orders of magnitude dynamic range as approaching 20 Hz. Sample droplets introduced into the OPI port 55 msec apart would result in two separate signal peaks where each peak intensity is independent of the adjacent peak to better than 99%. A low concentration sample droplet following a high concentration sample droplet would be clearly detectable as a separate signal peak if the lower concentration was 1% of the higher.

The technologies described herein may be utilized to manufacture analysis systems that operate in the air core mode, which allows for resolved analyzed signals that include defined peaks, widths, and an absence of noise (or substantial amounts thereof). For a known transport flow rate into the OPI, known conduit diameter, and known conduit length, the pressure generated at the nebulizer nozzle may be increased until the supercritical mode is achieved. The transport fluid ejected from the outlet is analyzed by the analysis device, e.g., a MS system. As described above, the signals attendant with the supercritical mode are often unresolved (e.g., characterized by wide, inconsistent peaks, noise, etc.). Once at the supercritical mode, the transfer conduit length may be adjusted (e.g., the conduit length may be reduced) until the signals generated by the detector reach a resolved condition. It has been determined that in certain cases, the signals will reach a resolved condition when the air core extends a length of about 90% to about 100% of the conduit length, or to other lengths thereof, as described herein. Alternatively, or in combination with the conduit length other parameters that govern the transport flow may also be used to control the onset of the air core flow mode. These parameters include but are not limited to the following: transport liquid properties such as viscosity and/or surface tension, conduit cross section such as its area and shape, material properties of the conduit walls that determine the interaction of the liquid with the solid wall, pressure drop providing the motive force to the transport liquid.

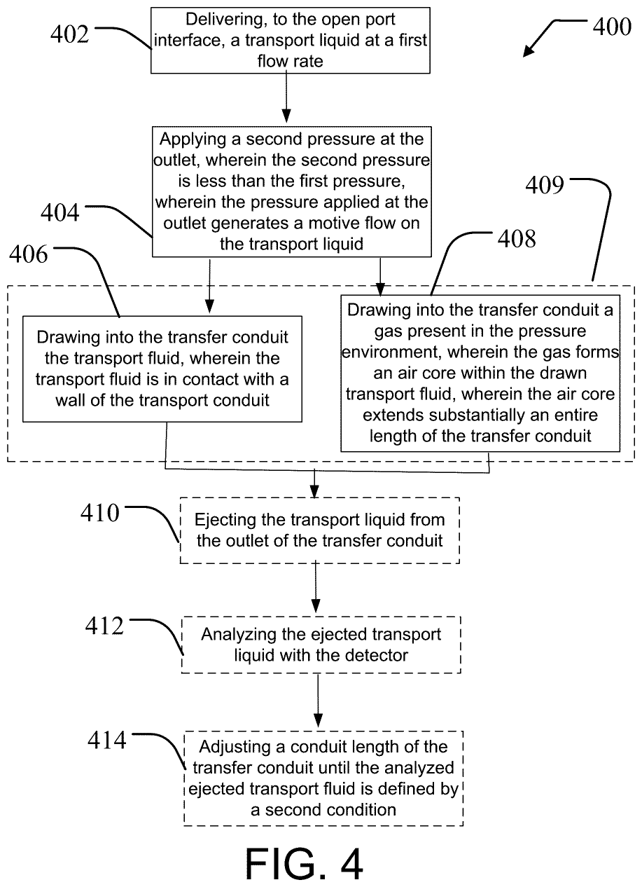

FIG. 4 depicts a method 400 of delivering transport fluid from an OPI to an outlet via a transfer conduit. The outlet may be the outlet of a nebulizer capillary or ionization source. The method 400 begins with operation 402, which includes delivering, to the OPI, a transport liquid at a first flow rate. The OPI is disposed in a pressure environment having a first pressure, which may be atmospheric pressure. In other examples, the first pressure may be greater than or less than atmospheric pressure, depending on the requirements of the space in which the OPI is located. For example, OPIs may be operated in a clean room where the pressure is higher than atmospheric. The method 400 includes operation 404, applying a second pressure at the outlet, wherein the second pressure is less than the first pressure, and wherein the pressure applied at the outlet generates a motive flow on the transport liquid. This motive flow is a result of the difference in the pressure environments at either end of the transport conduit. This pressure difference enables operation 406, drawing into the transfer conduit the transport fluid, wherein the transport fluid is in contact with a wall of the transport conduit. The difference in pressure also enables operation 408, drawing into the transfer conduit a gas present in the pressure environment, wherein the gas forms an air core within the drawn transport fluid, wherein the air core extends substantially an entire length of the transfer conduit. Operations 406 and 408 are performed concurrently, as indicated by dashed line 409. The entire length of the transfer conduit is defined at a first end by a sample inlet of the OPI and at a second end by the outlet, and the air core may extend along all or substantially all of this entire length. Examples that correspond to substantially all of the length are described elsewhere herein, and may include about 90% of the entire length, about 95% of the total length, and about 99% of the total length.

Additional optional operations 410-414 are further depicted. Operation 410 includes ejecting the transport liquid from the outlet of the transfer conduit. For example, this ejection may be performed at an ionization source, such as an ESI. Subsequent to this ejection, operation 412, analyzing the ejected transport liquid with the detector, is performed. The analyzed ejected transport fluid is defined by a first condition. In example, this first condition may be a signal that is unresolved, which may result from the presence of an air core that does not extend substantially the entire length of the transfer conduit. Thereafter, operation 414, adjusting a conduit length of the transfer conduit until the analyzed ejected transport fluid is defined by a second condition, is performed. In this second condition, the signal is resolved, in examples, because the air core has extended substantially the entire length of the transfer conduit. The terms “unresolved” and “resolved” are understood in the art and are based on at least one of a signal peak, a signal width, and a noise. An example of resolved state is a signal generated by two sample droplets ejected into the OPI port in sequence that are detected as independent signal in separate time packets adjacent to each other.

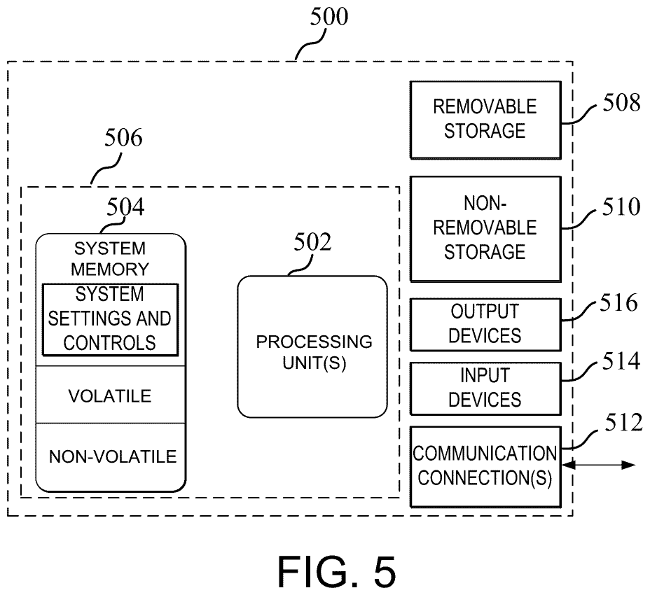

FIG. 5 depicts one example of a suitable operating environment 500 in which one or more of the present examples can be implemented. This operating environment may be incorporated directly into the controller for a mass spectrometry system, e.g., such as the controller depicted in FIG. 2. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 500 typically includes at least one processing unit 502 and memory 504. Depending on the exact configuration and type of computing device, memory 504 (storing, among other things, instructions to control the ejection of the samples, adjust an aspiration pressure or inflow flow rate, or perform other methods disclosed herein) can be volatile (such as RAM), non-volatile (such as ROM, flash memory, etc.), or some combination of the two. This most basic configuration is illustrated in FIG. 5 by dashed line 506. Further, environment 500 can also include storage devices (removable, 508, and/or non-removable, 510) including, but not limited to, magnetic or optical disks or tape. Similarly, environment 500 can also have input device(s) 514 such as touch screens, keyboard, mouse, pen, voice input, etc., and/or output device(s) 516 such as a display, speakers, printer, etc. Also included in the environment can be one or more communication connections 512, such as LAN, WAN, point to point, Bluetooth, RF, etc.

Operating environment 500 typically includes at least some form of computer readable media. Computer readable media can be any available media that can be accessed by processing unit 502 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 500 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 500 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 500 is part of a network that stores data in remote storage media for use by the computer system 500.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of delivering transport fluid from an open port interface to an outlet via a transfer conduit, the method comprising:
delivering, to the open port interface, a transport liquid at a first flow rate, wherein the open port interface is disposed in a pressure environment having a first pressure;
applying a second pressure at the outlet, wherein the second pressure is less than the first pressure, wherein the pressure applied at the outlet generates a motive flow on the transport liquid, thereby drawing into the transfer conduit (a) the transport fluid, wherein the transport fluid is in contact with a wall of the transport conduit, and (b) a gas present in the pressure environment, wherein the gas forms an air core within the drawn transport fluid, wherein the air core extends substantially an entire length of the transfer conduit.

2. The method of claim 1, wherein the first pressure is an atmospheric pressure and the second pressure is a pressure reduced below the atmospheric pressure.

3. The method of claim 1, wherein the entire length of the transfer conduit is defined at a first end by a sample inlet of the open port interface and at a second end by the outlet.

4. The method of claim 1, wherein the outlet comprises an outlet of a nebulizer capillary.

5. The method of claim 1, wherein the air core extends along about 95% of the entire length.

6. The method of claim 1, wherein the air core extends along about 99% of the entire length.

7. The method of claim 1, wherein the air core extends along the entire length.

8. A method of operating an analysis device comprising an open port interface, a transfer conduit coupled to the open port interface, and a detector disposed proximate an outlet of the transfer conduit, the method comprising:
delivering, to the open port interface, a transport liquid at a first flow rate, wherein the open port interface is disposed in a pressure environment having a first pressure;
generating a second pressure at the outlet of the transfer conduit, wherein the transfer conduit comprises a length, wherein the second pressure is less than the first pressure, wherein the pressure applied at the outlet generates a motive flow on the transport liquid, thereby drawing into the transfer conduit (a) the transport fluid, wherein the transport fluid is in contact with a wall of the transport conduit, and (b) a gas present in the pressure environment, wherein the gas forms an air core within the drawn transport fluid;
ejecting the transport liquid from the outlet of the transfer conduit;
analyzing the ejected transport liquid with the detector, wherein the analyzed ejected transport fluid is defined by a first condition; and
adjusting a conduit length of the transfer conduit until the analyzed ejected transport fluid is defined by a second condition.

9. The method of claim 8, wherein the length of the transfer conduit is defined at a first end by a sample inlet of the open port interface and at a second end by the outlet.

10. The method of claim 8, wherein the air core comprises an air core length, wherein the air core length comprises a first air core length at the first condition and a second air core length at the second condition.

11. The method of claim 8, wherein in the first condition, the analyzed ejected transport fluid comprises an unresolved signal, and wherein in the second condition, the analyzed ejected transport fluid comprises a resolved signal.

12. The method of claim 11, wherein the unresolved signal and the resolved signal are based on at least one of a signal peak, a signal width, and a noise.

13. The method of claim 10, wherein the second air core length comprises substantially all of the conduit length.

14. The method of claim 10, wherein the second air core length comprises about 90% of the conduit length.

15. The method of claim 10, wherein the second air core length comprises about 95% of the conduit length.

16. The method of claim 10, wherein the second air core length comprises about 99% of the conduit length.

17. A sample transfer conduit for delivering transport liquid from an open port interface to a mass spectrometer, the sample transfer conduit comprising:
a proximal end disposed in an atmospheric pressure environment and configured to receive a transport liquid and a sample;
a distal end disposed remote from the proximal end;
an ionization source connected to the distal end, wherein the ionization source is configured to operate at a pressure lower than the atmospheric pressure, wherein a pressure difference between the ionization source and the proximal end provides a motive force to the transport liquid through the conduit, wherein a flow of the transport liquid and the sample is disposed along the conduit walls, and wherein a flow of gas is generated within the flow of the transport liquid and the sample.

18. The sample transfer conduit of claim 17, wherein the flow of gas is generated along substantially the entire length of the sample transfer conduit.

19. The sample transfer conduit of claim 17, wherein the flow of gas is generated through a continuous gas channel.

20. The sample transfer conduit of claim 17, wherein a length of the sample transfer conduit is less than about 5 cm.
